(19) United States
(12) Patent Application Publication
(10) Pub. No.: US 2010/0246023 A1
(43) Pub. Date: Sep. 30, 2010

(54) Monocular type image display device

(75) Inventor: Tokifumi Tanaka, Aichi-gun (JP)

Correspondence Address: OLIFF & BERRIDGE, PLC, P.O. BOX 320850, ALEXANDRIA, VA, 22320-4850, US

(73) Assignee: BROTHER KOGYO KABUSHIKI KAISHA, NAGOYA-SHI (JP)

(21) Appl. No.: 12/801,394

(22) Filed: Jun. 7, 2010

Related U.S. Application Data
(63) Continuation-in-part of application No. PCT/JP2008/073795, filed on Dec. 26, 2008.

(30) Foreign Application Priority Data
Dec. 27, 2007 (JP) 2007-336045

(51) Int. Cl. G02B 27/01

(52) U.S. Cl. 359/630

(57) ABSTRACT

A monocular type image display device includes: a frame body having a front portion and a pair of temple portions connected to both side edges of the front portion; and an image display unit having an image forming part for forming an image based on an image signal and an eyepiece optical part for guiding the image formed by the image forming part to one of the eyes of a user. At least one of the pair of temple portions includes a mounting portion arranged adjacent to the front portion and a wearing portion positioned behind the mounting portion and supported on an ear of the user. A step in the height direction approximately orthogonal to a plane which includes the pair of temple portions is formed between the mounting portion and the wearing portion. The image display unit is mounted on the mounting portion.

### CROSS-REFERENCE TO RELATED APPLICATIONS

The present application is a Continuation-in-Part of International Application PCT/JP2008/073795 filed on Dec. 26, 2008, which claims the benefits of Japanese Patent Application No. 2007-336045 filed on Dec. 27, 2007.

### BACKGROUND

1. Field

The present invention relates to a monocular type image display device which a user can wear on his head.

2. Description of the Related Art

Recently, there has been popularly known an image display device of a type which a user can wear on his head, so-called Head-Mounted Display (hereinafter simply referred to as “HMD”).

The HMD is roughly classified into two types, that is, a binocular type HMD which is used in image observation using both eyes and a monocular type HMD which is used in image observation using a single eye. While the binocular type HMD requires a unit for displaying an image (hereinafter referred to as “image display unit”) on both eye sides, an image display unit is mounted in front of only a single eye in the monocular type HMD. Thus, the monocular type HMD is more lightweight and can be manufactured at a low cost compared to the binocular type HMD. Accordingly, except for a usage which requires a sensation of real life such as virtual reality, the monocular type HMD is more practical than the binocular type HMD.

However, since the image display unit is present on only one frame side in the monocular type HMD, the weight of the monocular type HMD is shifted to an image display unit mounting side. Accordingly, when a user puts the monocular type HMD on his head, the side of the monocular type HMD on which image display unit is mounted may be inclined downward. As a result, the image light which is incident on the eye of the user shifts downward from a proper incident position thus the image light may not be properly incident on the eye of the user. When a downward shift amount of the image light is increased, image light may not incident on the eye of the user, that is, a state where the user cannot see an image. To overcome this drawback, there has been proposed a method where a weight is additionally mounted on a portion of a frame on a side opposite to the image display unit mounting side as a counterweight to attain balance with the weight of the image display unit. Since the position of the center of gravity is adjusted by the weight, the downward inclination of the image display unit mounting side of the HMD is corrected so that the image display unit is held at the position at which the image light is properly incident on the eye of the user (hereinafter referred to as “proper position”).

### SUMMARY

In this manner, the conventional monocular type HMD requires the weight for holding the image display unit at the proper position. However, the method which additionally mounts the weight on the frame increases the weight of the frame leading to a possibility that the user will become tired from wearing the monocular type HMD.

Accordingly, it is an object of the present invention to provide a monocular type image display device which can hold an image display unit at a proper position without additionally providing a weight, and is lightweight compared to a conventional HMD.

### SUMMARY OF THE INVENTION

To overcome the above-mentioned drawback, according to one aspect of the present invention, there is provided a monocular type image display device which includes: a frame body having a front portion which is positioned in front of eyes of a user and is supported on a nose of the user, and a pair of temple portions which is connected to a left side edge and a right side edge of the front portion; and an image display unit having an image forming part which is configured to form an image based on an image signal and an eyepiece optical part which is configured to guide the image formed by the image forming part to one of the eyes of the user. Here, at least one of the pair of temple portions includes a mounting portion arranged adjacent to the front portion and a wearing portion which is positioned behind the mounting portion and is supported on an ear, a temporal portion or an occipital portion of the user. A step in the height direction approximately orthogonal to a plane which includes the pair of temple portions is formed between the mounting portion and the wearing portion. The image display unit is mounted on the mounting portion or the front portion arranged adjacent to the mounting portion.

In the above-mentioned constitution, the fore-and-aft direction implies the fore-and-aft direction of a line of sight of the user in a state where the user wears the monocular type image display device. The left-and-right direction implies the direction orthogonal to the direction of the line of sight of the user on a horizontal plane. The vertical direction (height direction) implies the direction approximately orthogonal to a plane which includes the pair of temple portions, that is, the vertical direction with respect to the user.

### BRIEF DESCRIPTION OF THE DRAWINGS

FIG. 1 is view showing the constitution of a monocular type image display device as viewed from the outside;

FIG. 2A is a view showing a method of mounting an image forming part on a mounting portion;

FIG. 2B is a view showing a method of mounting an image forming part on a mounting portion;

FIG. 3 is a view showing a connecting portion provided for connecting the mounting portion and a wearing portion;

FIG. 4A is a view showing a state where an engaging projecting portion is engaged with a connecting plate;

FIG. 4B is a view showing a state where an engaging projecting portion is engaged with a connecting plate;

FIG. 5A is a view showing an engaging state at the time of adjusting a step amount;

FIG. 5B is a view showing an engaging state at the time of adjusting the step amount;

FIG. 6A is a view showing a connecting portion of the monocular type image display device;

FIG. 6B is a view showing the connecting portion of the monocular type image display device;

FIG. 7A is a view showing an engaging state at the time of adjusting a step amount;

FIG. 7B is a view showing an engaging state at the time of adjusting the step amount;

FIG. 8A is a view showing a connecting portion of the monocular type image display device;

FIG. 8B is a view showing the connecting portion of the monocular type image display device;

FIG. 9A is a view showing a temple of the monocular type image display device; and

FIG. 9B is a view showing the temple of the monocular type image display device.

### DETAILED DESCRIPTION

Hereinafter, embodiments of the present invention are explained in detail in conjunction with attached drawings.

### One Embodiment

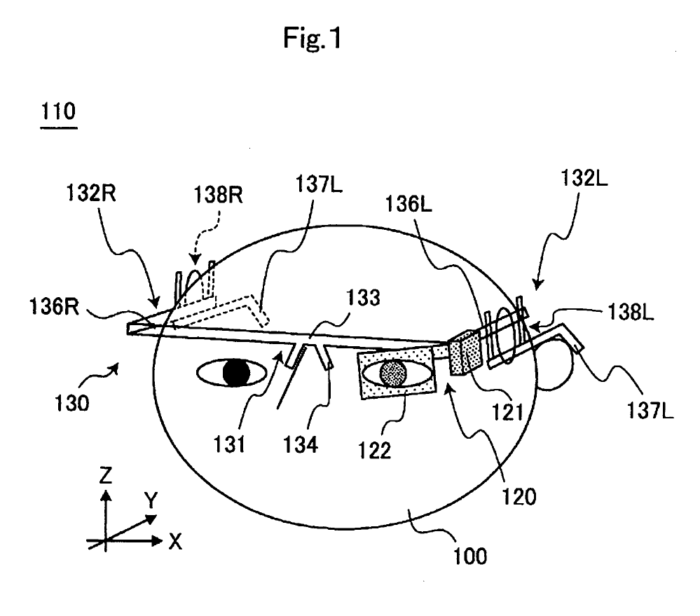

In a monocular type image display device 110 shown in FIG. 1, an image display unit 120 is constituted of an image forming part 121 and a half mirror 122. The image display unit 120 forms an image based on an image signal. The half mirror 122 guides an image formed by the image forming part 121 to one eye of the user 100. A frame 130 on which the image display unit 120 is detachably mounted includes a front portion 131 and left and right temples 132L, 132R. The front portion 131 is positioned in front of eyes of the user 100 when the user 100 wears the monocular type image display device 110 on his head. The left and right temples 132L, 132R extend backward in the direction approximately orthogonal to the front portion 131.

In the explanation made hereinafter, the fore-and-aft direction implies the fore-and-aft direction of the line of sight of the user 100 in a state where the user 100 wears the monocular type image display device 110. The left-and-right direction implies the direction orthogonal to the direction of the line of sight of the user 100 on a horizontal plane. The vertical direction implies the direction approximately orthogonal to a plane which includes the pair of temple portions 132L, 132R, that is, the vertical direction with respect to the user 100. In FIG. 1, the Y-axis direction, the X-axis direction and the Z-axis direction correspond to the fore-and-aft direction, the left-and-right direction, and the vertical direction respectively. Here, the vertical direction may be also referred to as the height direction.

### <Explanation of Image Display Unit>

The image display unit 120 is a so-called retinal scanning display. An extremely weak laser beam scanned in the horizontal direction as well as in the vertical direction by the image forming part 121 is reflected by the half mirror 122, and is incident on the pupil of the user 100. The laser beam which is incident on the pupil of the user 100 directly draws an image on the retina of the user 100. Here, the principle based on which an image is formed by such optical scanning is well-known and hence, the further explanation is omitted.

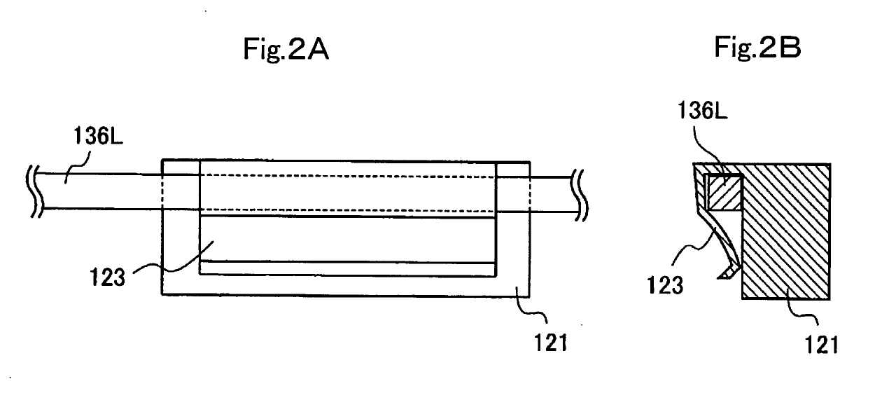

As shown in FIG. 2A and FIG. 2B, the image forming part 121 includes a clip 123. The clip 123 has resiliency and is formed into a shape where a distal end of the clip 123 is slightly bent toward the outside. By clamping a mounting portion 136L between the clip 123 and the image forming part 121, the image display unit 120 is mounted on the frame 130.

### <Explanation of Frame>

As shown in FIG. 1, a bridge 133 includes a nose pad 134. By bringing the nose pad 134 into contact with the nose of the user 100 when the user 100 wears the monocular type image display device 110, the front portion 131 is positioned in front of the eyes of the user 100.

The left temple 132L is divided into the mounting portion 136L on which the image display unit 120 is detachably mounted and a wearing portion 137L which is engaged with the ear of the user 100. The mounting portion 136L and the wearing portion 137L are connected with each other at a stepped portion 138L. The mounting portion 136L is positioned higher than the wearing portion 137L. In the same manner as the left temple 132L, the right temple 132R is also divided into a mounting portion 136R and a wearing portion 137R. The mounting portion 136R and the wearing portion 137R are, in the same manner, connected with each other with a step in the height direction at a stepped portion 138R. Since the stepped portion 138L in the height direction is formed on the temple 132L on a side where the image display unit 120 is mounted, the image display unit 120 is shifted upward compared to a case where such a stepped portion 138L is not formed on the temple 132L. As a result, an image light is properly incident on the eye of the user 100. That is, the image display unit 120 is held at a proper position. Further, since the monocular type image display device 110 adopts the simple constitution that the stepped portion 138L is formed on the temple 132L, it is possible to suppress the increase of the weight of the molecular image display device 110 compared to a case where a weight is added to the monocular type image display device 110.

The frame 130 is made of a titanium alloy. However, the frame 130 may be made of any material provided that the material imparts the required strength and portability to the frame 130. For example, titanium, a nickel-chromium alloy, a copper-nickel-zinc alloy, a magnesium alloy, an aluminum alloy, stainless steel or the like can be used when the frame 130 is made of metal, and celluloid, acetate, optil, an epoxy resin or the like can be used when the frame 130 is made of a resin.

### <Explanation of the Structure of the Stepped Portion 138>

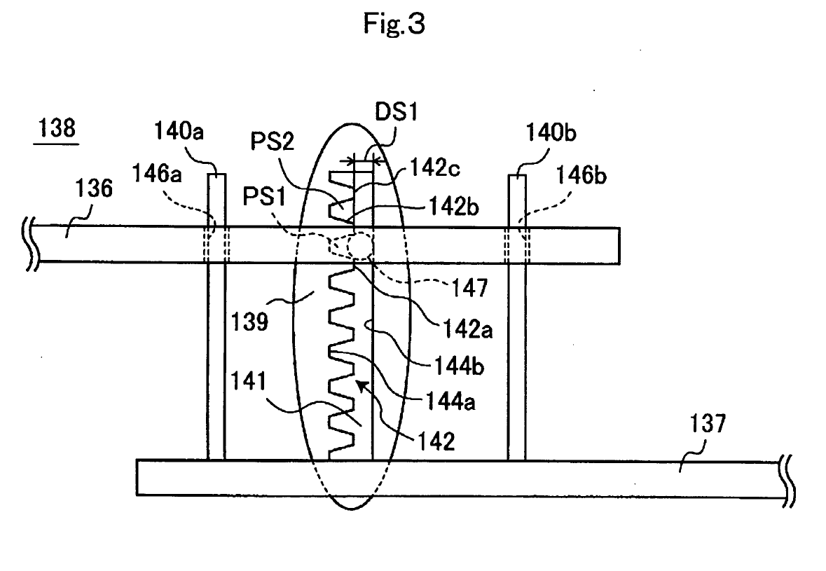

In FIG. 3 which shows the stepped portion 138 in an enlarged manner, both stepped portions 138L, 138R have the same structure. Although FIG. 3 shows the left stepped portion 138L as a representative of these stepped portions 138L, 138R, the stepped portion 138L is described as the stepped portion 138 by excluding symbol L, and the stepped portion 138 is explained hereinafter.

Cylindrical guide pins 140a, 140b are adhered to the wearing portion 137 using an adhesive agent such that the longitudinal direction of the guide pins 140a, 140b are approximately orthogonal to the wearing portion 137. The guide pins 140a, 140b are engaged with two through holes 146a, 146b which are formed in the mounting portion 136. The diameter of the through holes 146a, 146b is set slightly larger than the diameter of the guide pins 140a, 140b. Accordingly, the mounting portion 136 is slidable in the vertical direction in a state where the guide pins 140a, 140b are engaged with the through holes 146a, 146b.

An elliptical connecting plate 139 connects the mounting portion 136 and the wearing portion 137 to each other as a connecting portion. The connecting plate 139 is adhered to the wearing portion 137 by an adhesive agent such that the major-axis direction of the connecting plate 139 becomes approximately orthogonal to the wearing portion 137. A rectangular insertion hole 141 which allows the mounting portion 136 to be engaged with the connecting plate 139 is formed in the connecting plate 139. The longitudinal direction of the insertion hole 141 is approximately parallel to the longitudinal direction of the connecting plate 139. On an insertion-hole side wall 144a of the insertion hole 141 approximately parallel to the longitudinal direction of the insertion hole 141, a plurality of engaging pawls 142 which project toward an opposing insertion hole side wall 144b are formed. Each engaging pawl 142 is formed into a tapered shape. It is desirable that the connecting plate 139 and the plurality of engaging pawls 142 are made of a synthetic resin material (for example, NC nylon, polyamide or the like) which exhibits excellent elasticity and excellent wear resistance.

The temple 132L includes the insertion hole 141 and a large number of engaging pawls 142 as a step adjusting mechanism which is configured to adjust the stepped portion 138L. Accordingly, even when users who have different size faces use the same monocular type image display device, the user can hold the image display unit 120 at the proper position by adjusting the step each time the user changes. Further, the mounting portion 136L and the wearing portion 137L are connected to each other by the connecting plate 139 and hence, it is possible to connect the mounting portion 136L and the wearing portion 137L in a state where the stepped portion 138L in the height direction is provided between the mounting portion 136L and the wearing portion 137L. That is, it is possible to easily provide the stepped portion 138L between the mounting portion 136L and the wearing portion 137L. Further, due to the provision of the step adjusting mechanism, for example, even when the image forming unit 120 is replaced with another image display unit 120 having the different weight or even when the mounting position of the mounting portion 136L on which the image display unit 120 is mounted is slightly changed due to a mounting operation or a detaching operation, it is possible to always hold the image display unit 120 at the proper position. That is, by detachably mounting the image display unit 120 on the mounting portion 136L, the usefulness of the step adjusting mechanism is further enhanced. Still further, since the wearing portion 137L is fixed to the connecting plate 139, the user 100 can move the mounting portion 136L in the vertical direction while maintaining the state where the wearing portion 137L is in contact with an ear, a temporal portion or an occipital portion of the user 100. Further, since the wearing portion 137L is supported on the ear, the temporal portion or the occipital portion of the user 100, the user 100 can conduct the step adjustment with the monocular type image display device 110 held in a stable state.

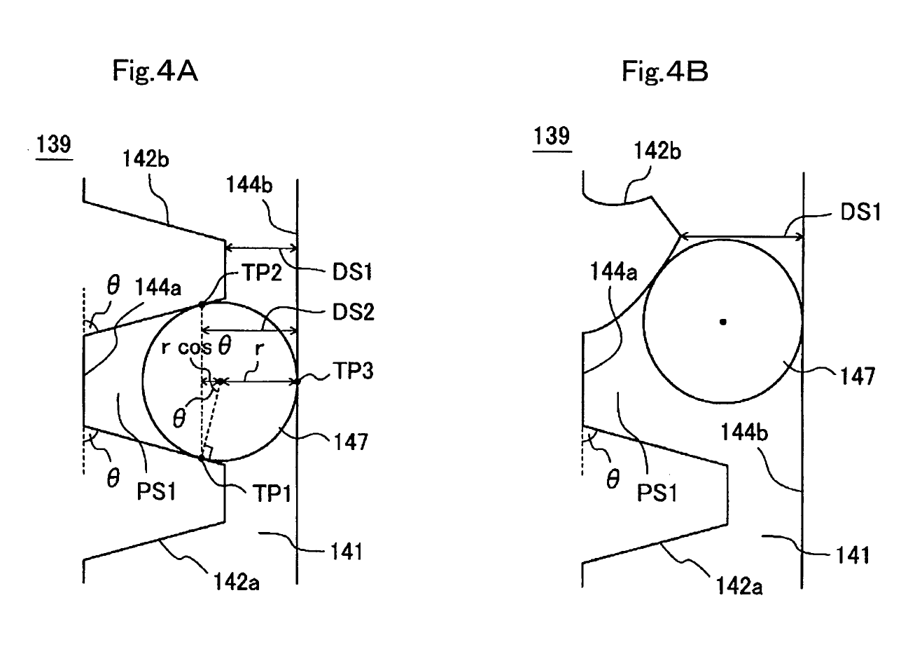

The mounting portion 136 includes a cylindrical engaging projecting portion 147 which extends in the depth direction perpendicular to the sheet surface of FIG. 3. The engaging projecting portion 147 is inserted into an engaging position PS1 surrounded by the side wall 144b, the engaging pawl 142a and the engaging pawl 142b positioned above the engaging pawl 142a. As shown in FIG. 4A, assume a radius of the engaging projecting portion 147 as “r” and an inclination angle of the engaging pawls 142a, 142b as “θ”. Further, assume a contact point between the engaging projecting portion 147 and the engaging pawl 142a as “TP1”, a contact point between the engaging projecting portion 147 and the engaging pawl 142b as “TP2”, and a contact point between the engaging projecting portion 147 and the insertion hole side wall 144b as “TP3”. Assuming a distance between a straight line which passes the contact points TP1, TP2 and the contact point TP3 as “DS2”, the distance DS2 is equivalent to distances from the contact points TP1, TP2 to the insertion hole side wall 144b. Here, when the distance DS2 satisfies the following formula (1), since the engaging pawls 142a, 142b have elasticity as described previously, when the engaging projecting portion 147 is inserted into the engaging position PS1, the distance between the contact point TP1 and the contact point TP2 is expanded by pushing of the engaging pawl 142b. Since a frictional force is generated at the contact points TP1, TP2 and TP3 due to such expanding of the distance, the engaging projecting portion 147 is engaged at the engaging position PS1.

DS2<r×(1+cos θ) (1)

### <Step Adjusting Method>

Using FIG. 3, FIG. 4A and FIG. 4B, the explanation is made hereinafter with respect to an example of the step adjustment where the engaging projecting portion 147 inserted into the engaging position PS1 is moved to an engaging position PS2 arranged above the engaging position PS1 by one step. When the engaging projecting portion 147 is pushed upward, the engaging pawl 142b which receives a pushing force is elastically deformed upward and hence, the distance DS1 between the engaging pawl 142b and the insertion hole side wall 144b is expanded (state shown in FIG. 4B). When the force which pushes the engaging projecting portion 147 upward exceeds a predetermined value, the distance DS1 becomes larger than the diameter of the engaging projecting portion 147. As a result, the engaging projecting portion 147 is moved to the engaging portion PS2 surrounded by the side wall 144b, the engaging pawl 142b and an engaging pawl 142c positioned above the engaging pawl 142b. The resiliently deformed engaging pawl 142b restores an original shape so that the engaging projecting portion 147 is engaged at the engaging position PS2. The force necessary for this movement is sufficiently larger than a force which the weight of the image display unit 120 and the weight of the frame 130 apply to the engaging projecting portion 147. That is, unless the user 100 applies an upward (or downward) force to the engaging projecting portion 147, the engaging projecting portion 147 is not moved. By repeating the pushup (or the pushdown) operation of the engaging projecting portion 147, it is possible to adjust a step amount between the mounting portion 136 and the wearing portion 137 in a stepped manner. In this manner, with the provision of the step adjusting mechanism which can manually adjust the step, a drive mechanism (motor, actuator or the like) for changing the step becomes unnecessary thus suppressing the increase of the weight of the monocular type image display device.

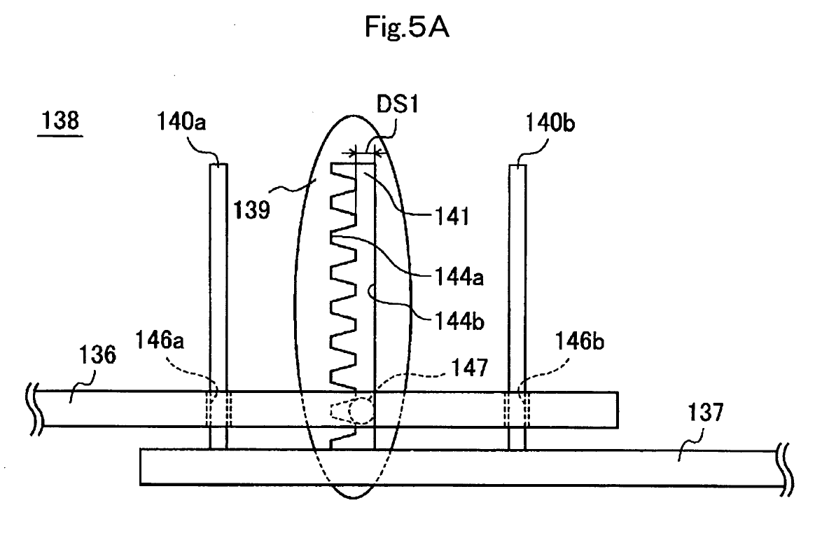

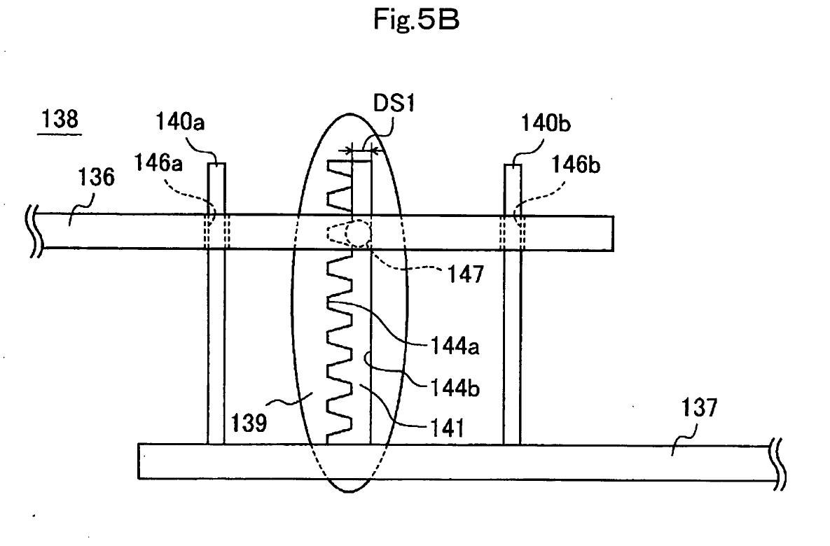

With the use of the above-mentioned step adjusting mechanism, it is possible to maintain the balance of the monocular type image display device in the lateral direction in a state where the image display unit 120 is mounted on the frame 130. Hereinafter, a mode where the step adjusting mechanism is used at the time of mounting the image display unit 120 on the frame 130 is explained in conjunction with FIG. 5.

Here, the user 100 wears the frame 130 (see FIG. 1) on his head in a state where the image display unit 120 is not mounted on the frame 130. The step of either one of left and right stepped portions 138L, 138R is set to minimum (state shown in FIG. 5A). The front portion 131 is held in an approximately horizontal state. When the image display unit 120 is mounted on the left-side mounting portion 136L, the center of gravity of the whole monocular type image display device 110 is shifted to a left side. As a result, the front portion 131 is inclined leftward using the nose of the user as a fulcrum so that the image display unit 120 is moved downward from a proper position.

Then, the user adjusts the step between the mounting portion 136L and the wearing portion 137L so as to hold the image display unit 120 (see FIG. 1) at the proper position. Firstly, the user holds the wearing portion 137L with his left hand so as to prevent the wearing portion 137L from moving in the vertical direction from a state where the wearing portion 137L is in contact with his ear. Next, the user raises the mounting portion 136L with his right hand until the image display unit 120 assumes the proper position. The mounting portion 136L is moved upward from the first engaging portion and is engaged at a new position (state shown in FIG. 5B). The step between the mounting portion 136L and the wearing portion 137L is held at this position even when the user separates his hand and hence, the image display unit 120 is held at the proper position. In this manner, by merely moving the mounting portion 136L in the vertical direction, the user can easily adjust the step. Further, by providing the mounting portions 136L, 136R, the wearing portions 137L, 137R and the step adjusting mechanism on both left and right sides of the pair of temples 132L, 132R, it is possible to adjust the step on both left and right sides. In this manner, even when the image display unit 120 is mounted on either the left or the right side, it is possible to hold the image display unit 120 at the proper position. Accordingly, the user 100 can select the side on which the image display unit 120 is mounted in conformity with his dominant eye, for example.

### Another Embodiment

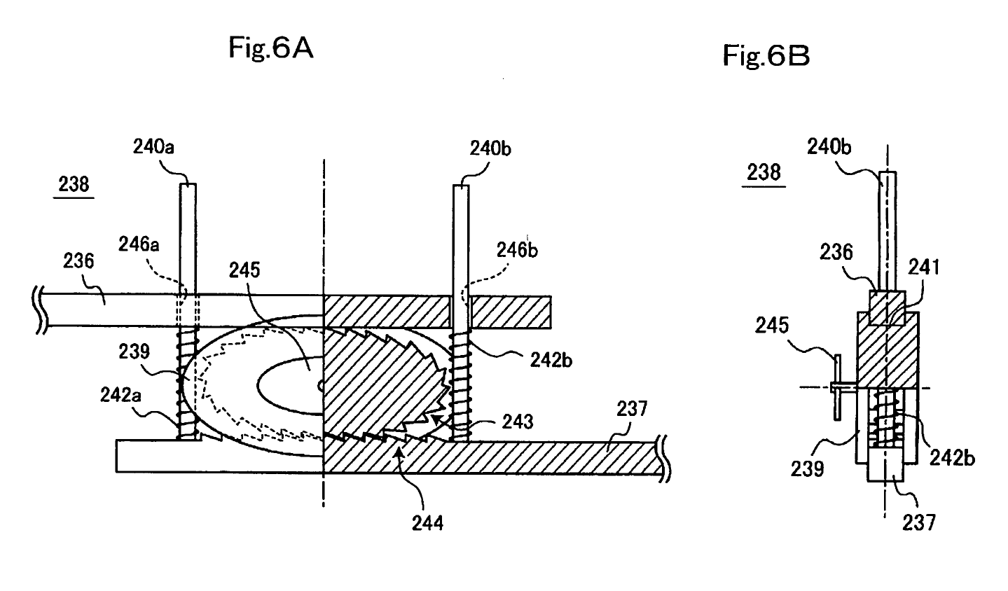

Another embodiment of this disclosure differs from one embodiment described in FIG. 1 with respect to only the shape of the stepped portion. Here, the explanation is made hereinafter with respect to the stepped portion 238 which is the gist of another embodiment in conjunction with FIG. 6A and FIG. 6B.

<Explanation of structure of stepped portion 238>

An elliptical cam 239 for step adjustment has an elliptical columnar profile as viewed from one side, and is positioned between a mounting portion 236 and a wearing portion 237. An elliptical adjustment tab 245 is adhered to an elliptical cam 239 by an adhesive agent such that the axis of rotation of the elliptical adjustment tab 245 substantially agrees with the axis of rotation of the elliptical cam 239. On the plane of the elliptical cam 239 parallel to the axis of rotation of the elliptical cam 239, an engaging groove 241 which is engaged with a mounting portion 236, a wearing portion 237 and guide pins 240a, 240b are formed. A rack 243 is formed on a surface of the engaging groove 241. The rack 243 is engaged with pawls 244 formed on the mounting portion 237 thus constituting a ratchet. Accordingly, the elliptical cam 239 is rotatable only in the clockwise direction as viewed from the side on which the adjustment tab 245 is fixed. That is, the user 100 can adjust a step by merely rotating the adjustment tab 245.

Cylindrical guide pins 240a, 240b are adhered to the wearing portion 237 using an adhesive agent such that the longitudinal direction of the guide pins 240a, 240b is approximately orthogonal to the wearing portion 237. The guide pins 240a, 240b are engaged with two through holes 246a, 246b formed in the mounting portion 236. The diameter of these through holes is set slightly larger than the diameter of the guide pins 240a, 240b. Accordingly, the mounting portion 236 is slidable in the vertical direction in a state where the guide pins 240a, 240b are engaged with the through holes 246a, 246b. The distance between the guide pin 240a and the guide pin 240b is slightly larger than a major-axis diameter of the elliptical cam 239 at the engaging groove 241.

Helical springs 242a, 242b are wound around the guide pins 240a, 240b. Upper ends of the helical springs 242a, 242b are adhered to the mounting portion 236, and lower ends of the helical springs 242a, 242b are adhered to the wearing portion 237 respectively using an adhesive agent. The natural length of the helical springs 242a, 242b is shorter than the minor-axis diameter of the elliptical cam 239 at the engaging groove 241 so that the helical springs 242a, 242b are always extended. Accordingly, the helical springs 242a, 242b generate a tension between the mounting portion 236 and the wearing portion 237. This tension holds the mounting portion 236 and the wearing portion 237 in an engaged state with the engaging groove 241. Since the engaging groove 241 is formed on the elliptical cam 239, a stable engagement state can be held. Compared to a case where the engaging groove 241 is formed on both the mounting portion 236 and the wearing portion 237, the stepped portion can be manufactured more easily.

### <Step Adjustment Method>

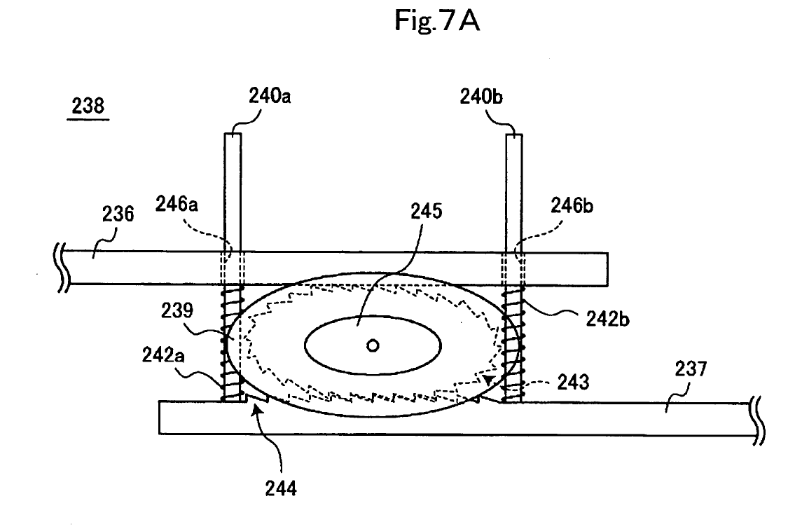

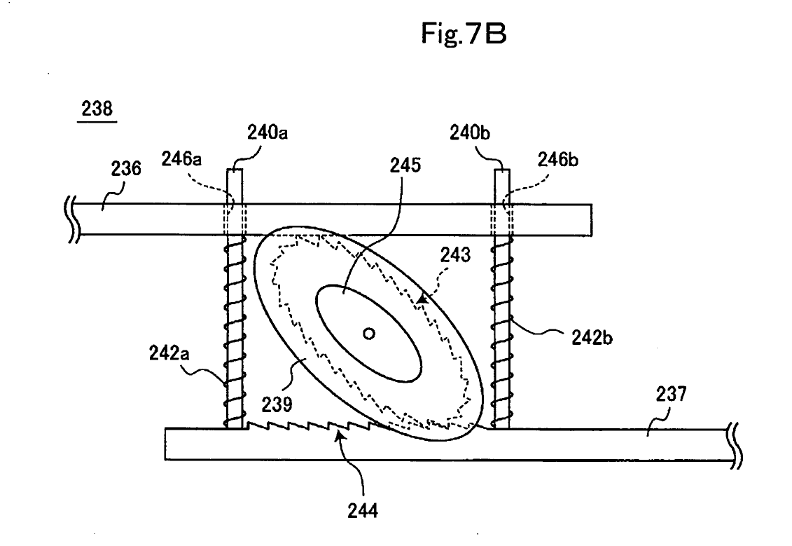

The method of adjusting a step amount between the mounting portion 236 and the wearing portion 237 according to this embodiment is explained. In FIG. 7A, the minor-axis direction of the elliptical cam 239 is approximately parallel to the vertical direction. That is, a step between the mounting portion 236 and the wearing portion 237 assumes a minimum state. The user rotates the adjustment tab 245 in the clockwise direction. The elliptical cam 239 is rotated in the clockwise direction in an interlocking manner with the adjustment tab 245, and pushes up the mounting portion 236 relative to the wearing portion 237 (state shown in FIG. 7B). In such a state, a restoring force which the helical springs 242a, 242b generate imparts a torque for rotating the elliptical cam 239 in the counterclockwise direction to the elliptical cam 239. However, since the racks 243 and pawls 244 which engage with each other prevent the rotation of the elliptical cam 239 in the counterclockwise direction and hence, the elliptical cam 239 is held at the position shown in FIG. 7B. That is, the user can adjust a step amount between the mounting portion 236 and the wearing portion 237 only by rotating the adjustment tab 245 in the clockwise direction. Since the step can be adjusted by displacing the elliptical cam 239 using the adjustment tab 245 with a single hand, the step can be easily adjusted.

### Another Embodiment

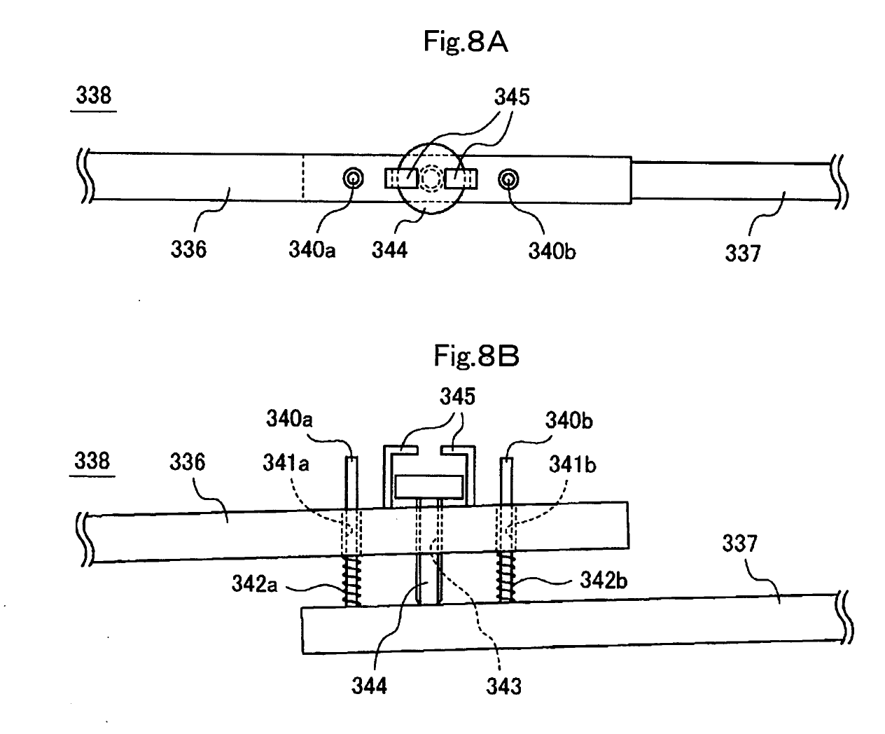

Another embodiment of this disclosure differs from one embodiment described in FIG. 1 with respect to only a shape of the stepped portions 138L, 138R. Here, the explanation is made hereinafter with respect to a stepped portion 338 which is the gist of another embodiment in conjunction with FIG. 8A and FIG. 8B.

Cylindrical guide pins 340a, 340b are adhered to a wearing portion 337 using an adhesive agent such that the longitudinal direction of the guide pins 340a, 340b is approximately orthogonal to the wearing portion 337. The guide pins 340a, 340b are engaged with two through holes 341a, 341b formed in a mounting portion 336. The diameter of the through holes 341a, 341b is set slightly larger than the diameter of the guide pins 341a, 341b. Accordingly, the mounting portion 336 is slidable in the vertical direction in a state where the guide pins 340a, 340b are engaged with the through holes 341a, 341b.

Helical springs 342a, 342b are wound around the guide pins 340a, 340b respectively. Upper ends of the helical springs 342a, 342b are adhered to the mounting portion 336, and lower ends of the helical springs 342a, 342b are adhered to the wearing portion 337 respectively using an adhesive agent. The helical springs 342a, 342b are always extended so that a tension is generated between the mounting portion 336 and the wearing portion 337.

An adjusting screw 344 is threadedly engaged with a threaded hole 343 formed in the mounting portion 336 in a vertically penetrating manner. Stoppers 345 are mounted on an upper surface of the mounting portion 336 in front of and behind the threaded hole 343. The stoppers 345 prevent the removal of the adjusting screw 344 from the threaded hole 343 when the adjusting screw 344 loosens. An under-head length of the adjusting screw 344 is larger than a depth of the threaded hole 343. Accordingly, by fastening the adjusting screw 344, a head of the adjusting screw 344 which projects downward from the threaded hole 343 is brought into contact with the wearing portion 337. By further fastening the adjusting screw 344 from such a state, the wearing portion 337 is moved downward with respect to the mounting portion 336. That is, the step amount is adjusted by adjusting a fastening amount of the adjusting screw 344.

### Another Embodiment

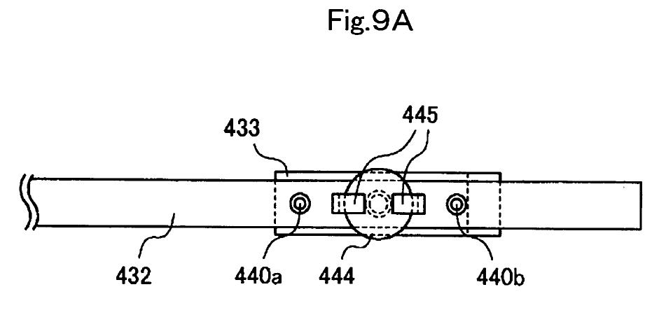

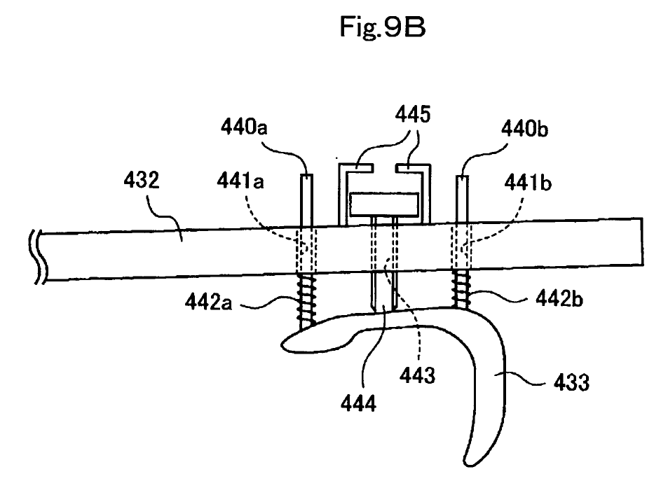

Another embodiment of this present invention is explained in conjunction with FIG. 9A and FIG. 9B. FIG. 9A shows a state where a temple 432 is viewed from above, and FIG. 9B shows a state where the temple 432 is viewed from a side. In this embodiment, the temple 432 is not divided, and an ear pad 433 which is brought into contact with an ear of the user is provided below the temple 432. The distance between the ear pad 433 and the temple 432 is variable.

Cylindrical guide pins 440a, 440b are adhered to the ear pad 433 using an adhesive agent such that the longitudinal direction of the guide pins 440a, 440b is approximately parallel to the vertical direction. The guide pins 440a, 440b are engaged with two through holes 441a, 441b formed in the temple 432. The diameter of these through holes 441a, 441b is set slightly larger than the diameter of the guide pins 440a, 440b. Accordingly, the temple 432 is slidable in the vertical direction in a state where the guide pins 440a, 440b are engaged with the through holes 441a, 441b.

Helical springs 442a, 442b are wound around the guide pins 440a, 440b. Upper ends of the helical springs 442a, 442b are adhered to the temple 432, and lower ends of the helical springs 442a, 442b are adhered to the ear pad 433 respectively using an adhesive agent. The helical springs 442a, 442b are always in a pulled state so that a tension is generated between the temple 432 and the ear pad 433.

An adjusting screw 444 is threadedly engaged with a threaded hole 443 formed in the temple 432 in a vertically penetrating manner. Stoppers 445 are mounted on an upper surface of the temple 432 in front of and behind the threaded hole 443. The stoppers 445 prevent the removal of the adjusting screw 444 from the threaded hole 443 which may occur when the adjusting screw 444 is excessively loosened. The under-head length of the adjusting screw 444 is larger than the depth of the threaded hole 443. Accordingly, by fastening the adjusting screw 444, a head of the adjusting screw 444 which projects downward from the threaded hole 443 is brought into contact with the ear pad 433. By further fastening the adjusting screw 444 from such a state, the ear pad 433 is moved downward with respect to the temple 432. That is, the distance between the ear pad 433 and the temple 432 is changed by adjusting a fastening amount of the adjusting screw 444.

### Modification

The present invention is not limited to the above-mentioned embodiments, and various modifications and variations are conceivable without departing from the gist of the present invention. Some modifications are explained hereinafter.

### Another Embodiment

In the above-mentioned embodiments, an adhesive agent is used for fixing the connecting plate 139 to the wearing portion 137 (see FIG. 3). However, the connecting plate 139 may be fixed to the wearing portion 137 by an arbitrary method such as screw fixing or rivet fixing. Other portions which are adhered using an adhesive agent may also be fixed in the same manner. Further, when the frame 130 is made of a synthetic resin material, the connecting plate 139 may be integrally molded with the wearing portion 137. The connecting plate 139 may be fixed to the mounting portion 136, and the engaging projecting portion 147 may be formed on the wearing portion 137. Further, an engaging projecting portion may be formed on both the mounting portion 136 and the wearing portion 137, and both the mounting portion 136 and the wearing portion 137 may be engaged with the connecting plate 139.

The shape of the large number of engaging pawls 142 is not limited. For example, the engaging pawls 142 may be formed into any shape such as a semicircular shape, a serrated shape or the like provided that the engaging pawls 142 are engageable with engaging projecting portion 147. Further, the large number of engaging pawls 142 may be formed on both the insertion-hole side walls 144a, 144b of the insertion hole 141. Alternatively, the insertion hole 141 may not be provided with the large number of engaging pawls 142 at all. In this case, when a width of the insertion hole 141 in the lateral direction is smaller than a diameter of the engaging projecting portion 147, a frictional force acts between the engaging projecting portion 147 inserted into the insertion hole 141 and the insertion-hole side walls 144a, 144b which are brought into contact with the engaging projecting portion 147. When the frictional force is sufficiently larger than the force which the weight of the image display unit 120 and the weight of the frame 130 apply to the engaging projecting portion 147, the engaging projecting portion 147 is engaged. In this case, the engaging projecting portion 147 is engageable at an arbitrary height in the insertion hole 141 and hence, a step amount is continuously adjustable.

In the above-mentioned embodiment (see FIG. 6), for example, the elliptical cam 239 is replaceable with a plate cam having another shape (egg shape or the like) and having the center of rotation. Alternatively, the elliptical cam 239 is also replaceable with a cam which does not have the center of rotation (for example, translation cam or the like).

A means other than the ratchet may be used for holding the elliptical cam 239 at the position after the step adjustment. For example, the elliptical cam 239 may be engaged with the mounting portion 236 and the wearing portion 237 by making use of a frictional force which acts on a contact portion between the elliptical cam 239 and the mounting portion 236 and a contact portion between the elliptical cam 239 and the wearing portion 237. In this case, it is desirable to apply the process which increases the surface roughness or the like to the contact portions for increasing frictional coefficients of the contact portions. By forming the elliptical cam 239 such that the elliptical cam 239 is engageable with the mounting portion 236 and the wearing portion 237 by making use of the friction, the elliptical cam 239 is rotatable in both directions, that is, in the clockwise direction as well as in the counterclockwise direction.

The engaging groove 241 formed on the elliptical cam 239 may be formed on the mounting portion 236 and the wearing portion 237. In this case, a recessed groove or an engaging recessed portion is formed in a portion of the mounting portion 236 and a portion of the wearing portion 237 which are brought into contact with the elliptical cam 239, and the elliptical cam 239 is engaged with these grooves.

The helical springs 242a, 242b may be replaced with two springs consisting of a spring which connects the elliptical cam 239 and the mounting portion 236 and a spring which connects the elliptical cam 239 and the wearing portion 237.

In the above-mentioned embodiment (see FIG. 8), the threaded hole 343 may be formed in the wearing portion 337. In this case, the stopper 345 is mounted on a lower surface of the wearing portion 337, and an adjusting screw which is threadedly engaged with the threaded hole formed in the wearing portion 337 pushes up the mounting portion 336.

In the above-mentioned embodiment, a tension acts between the mounting portion and the wearing portion using the helical springs. As a substitute for the helical springs, an elastic member having the similar effect (for example, various springs (plate spring, disc spring or the like), rubber or the like) may be used.

The guide pins used in the above-mentioned embodiment facilitates the step adjustment by limiting the moving direction of the mounting portion only in the height direction. However, the provision of the guide pins is arbitrary, and there arises no problem even when they are not provided.

In the above-mentioned embodiment, to adjust the step between the mounting portion and the wearing portion, the connecting plate 139, the elliptical cam 239 and the adjusting screw 344 are used. In place of these parts, the step adjustment may be also performed using magnets (for example, permanent magnets such as ferrite magnets or neodymium magnets). For example, the magnets are adhered to the mounting portion and the wearing portion respectively, and the magnets have surfaces which face each other in an opposed manner in the fore-and-aft direction or in the left-and-right direction. When the magnets are arranged such that the magnetic poles on the opposing surfaces differ from each other, it is possible to connect the mounting portion and the wearing portion by making use of an attraction force which acts between the different poles of the magnets. In this case, the mounting portion and the wearing portion are not mechanically connected with each other, but are magnetically connected only at portions where the magnets are brought into contact with each other and hence, the mechanically connecting portion becomes unnecessary. Further, by changing the position where the opposing surfaces are in contact with each other, it is possible to adjust a step amount between the mounting portion and the wearing portion.

Power necessary for adjusting the step is not limited to manual power, and the step may be adjusted using an electrically operated mechanism such as a motor or an actuator.

When the image display unit is mounted on the temple, the temple is moved downward due to the weight of the image display unit. In the above-mentioned embodiment, the image display unit is held at the proper position by lifting the temple on the image display unit mounting side. However, the image display unit may be held at the proper position by adjusting the step formed on the image display unit non-mounting side.

The image display unit 120 may be mounted on the front portion. In the embodiment of the present invention, as shown in FIG. 1, for example, the image display unit 120 is mounted on the mounting portion 136L, 136R which constitutes a portion of the temple 132L, 132R which is connected to a left side edge or a right side edge of the front portion. However, the image display unit 120 may be configured such that the image display unit 120 is mounted on the left and right end portions of the front portion 131 arranged adjacent to the mounting portions 136L, 136R. Further, the half mirror 122 may be fixed to the front portion 131 such that the half mirror 122 is arranged in front of the eye of the user, and only the image forming part 121 may be detachably mounted on the mounting portion 136L, 136R (or the front portion 131). The mounting method of the image display unit 120 (or image forming part 121) on the mounting portions 136L, 136R (or the front portion 131) is not limited to the method which uses the clip 123, and may be a method which uses screws or the like. Further, the image display unit 120 (or image forming part 121) is not limited to the detachable constitution, and the constitution which fixes the image display unit 120 on the mounting portion 136L, 136R (or the front portion 131) completely falls within the gist of this disclosure.

The image display unit 120 may, provided that the image display unit 120 can project an image on the eye of the user, not be limited to the retinal scanning display. For example, the image display unit 120 may be configured to guide an image displayed on a two-dimensional display element such as a liquid crystal panel or an organic EL display to the eye of the user. Further, the method which guides light from the image forming part 121 to the eye of the user is not limited to the half mirror 122. For example, a transparent lens which forms a reflection surface in the inside thereof may be used.

### [Advantageous Effects Acquired by the Embodiment]

In the above-mentioned embodiments, the step in the height direction is formed on the temple portion. Assuming a case where the temple portion has no step, due to the weight of the image display unit 120, the side edge of the front portion on which the image display unit 120 is mounted is positioned below the side edge of the front portion on which the image display unit 120 is not mounted. That is, the front portion is inclined obliquely so that an image light which is incident on the eye of the user is moved downward to a position below the proper incident position. On the other hand, when the step in the height direction is formed on the temple portion on the side where the image display unit 120 is mounted, the image display unit 120 is moved upward and hence, the image light is properly incident on the eye of the user. That is, the image display unit 120 is held at the proper position.

The step adjusting mechanism includes the plurality of engaging portions arranged at different positions in the height direction. Then, the engaging portion is engaged with at least one of the mounting portion and the wearing portion. Accordingly, by changing the engaging portion with which the mounting portion or the wearing portion is engaged, the user can adjust the step between the mounting portion and the wearing portion in a stepped manner.

The step adjusting mechanism may be provided to the connecting plate 139 as an example. The wearing portion 137 is fixed to the connecting plate 139, and the mounting portion 136 is engaged between the arbitrary engaging pawls. Since the step adjustment can be performed by merely changing the engaging position of the mounting portion 136, it is possible to facilitate the step adjustment compared to a case where both engaging positions of the mounting portion 136 and the wearing portion 137 are changeable.

What is claimed is:

1. A monocular type image display device comprising:
a frame body having a front portion which is positioned in front of eyes of a user and is supported on a nose of the user, and a pair of temple portions which is connected to a left side edge and a right side edge of the front portion; and
an image display unit having an image forming part which is configured to form an image based on an image signal and an eyepiece optical part which is configured to guide the image formed by the image forming part to one of the eyes of the user, wherein
at least one of the pair of temple portions includes a mounting portion arranged adjacent to the front portion, and a wearing portion which is positioned behind the mounting portion and is supported on an ear, a temporal portion or an occipital portion of the user,
a step in a height direction approximately orthogonal to a plane which includes the pair of temple portions is formed between the mounting portion and the wearing portion, and
the image display unit is mounted on the mounting portion or the front portion arranged adjacent to the mounting portion.

2. The monocular type image display device according to claim 1, wherein at least one of the pair of temple portions includes a step adjusting mechanism which is configured to adjust the step.

3. The monocular type image display device according to claim 2, wherein the step adjusting mechanism is configured to adjust the step manually.

4. The monocular type image display device according to claim 2, wherein the step adjusting mechanism includes a plurality of engaging portions which are arranged at different positions in the height direction, and
the engaging portions are engaged with at least one of the mounting portion and the wearing portion.

5. The monocular type image display device according to claim 4, wherein at least one of the pair of temple portions includes the mounting portion and the wearing portion which are divided from each other as separate bodies, and a connecting portion which connects the mounting portion and the wearing portion.

6. The monocular type image display device according to claim 5, wherein the step adjusting mechanism is mounted on the connecting portion, either one of the mounting portion and the wearing portion is connected to the connecting portion, and the other of the mounting portion and the wearing portion is engaged with any one of the plurality of engaging portions.

7. The monocular type image display device according to claim 6, wherein the wearing portion is connected to the connecting portion, and the mounting portion is engaged with any one of the plurality of engaging portions.

8. The monocular type image display device according to claim 5, wherein the step adjusting mechanism includes:
an insertion hole into which at least either one of the mounting portion and the wearing portion is inserted, the insertion hole being formed in the connecting portion in an elongated manner in the height direction; and
a plurality of engaging pawls which are formed on at least one of a pair of side walls extending in a longitudinal direction of the insertion hole and have elasticity, and the engaging portion is configured to hold at least one of the mounting portion and the wearing portion by any two of the plurality of engaging pawls which are arranged adjacent to each other.

9. The monocular type image display device according to claim 2, wherein the step adjusting mechanism comprises:
an adjusting cam which is positioned between the mounting portion and the wearing portion;
a cam adjusting tab which is formed on the adjusting cam; and
a cam holding mechanism which holds the adjusting cam in a state where the adjusting cam is engaged with the mounting portion and the wearing portion.

10. The monocular type image display device according to claim 9, wherein the adjusting cam includes the center of rotation, and is configured to be rotated in an interlocking manner with the rotation of the cam adjusting tab.

11. The monocular type image display device according to claim 10, wherein the cam holding mechanism comprises:
an engaging recessed portion which engages the adjusting cam with the mounting portion and the wearing portion and is formed on either the mounting portion and the wearing portion, or the adjusting cam; and
an elastic member which is configured to maintain a state where the adjusting cam is engaged with the mounting portion and the wearing portion.

12. The monocular type image display device according to claim 11, wherein the engaging recessed portion is formed on the adjusting cam, and the elastic member is arranged between the mounting portion and the wearing portion.

13. The monocular type image display device according to claim 2, wherein the mounting portion, the wearing portion and the step adjusting mechanism are arranged on left side and right side of the pair of temple portions.

14. The monocular type image display device according to claim 1, wherein the image display unit or the image forming part is detachably mounted on the mounting portion or the front portion arranged adjacent to the mounting portion.
